(19) United States
(12) Patent Application Publication
(10) Pub. No.: US 2024/0094080 A1
(43) Pub. Date: Mar. 21, 2024

(54) VACUUM PRESSURE GAUGE ASSEMBLY WITH LIGHT INDICATION

(71) Applicant: Edwards Limited, Burgess Hill, Sussex (GB)

(72) Inventors: Bishoy Zakaria, Eastbourne Sussex (GB); Ylber Doniku, Eastbourne Sussex (GB); Daniel David, Eastbourne Sussex (GB)

(21) Appl. No.: 18/263,779

(22) PCT Filed: Feb. 1, 2022
(86) PCT No.: PCT/GB2022/050261

§ 371 Date: Aug. 1, 2023

(30) Foreign Application Priority Data
Feb. 3, 2021 (GB) 2101447.7

(51) Int. Cl. G01L 19/12; G01L 21/00

(52) U.S. Cl. CPC G01L 19/12; G01L 21/00

(57) ABSTRACT

A vacuum pressure gauge assembly includes a body, a pressure transducer received within the body, a microcontroller received within the body and configured to receive a signal indicative of a pressure from the pressure transducer, and at least one light emitting device in communication with the microcontroller. The microcontroller is configured to process the signal from the pressure transducer to determine the pressure, and to control the at least one light emitting device to display a first light pattern when the pressure is within a first pressure range and a second light pattern different from the first light pattern when the pressure is within a second pressure range different from the first pressure range. At least one of the first light pattern and the second light pattern varies in intensity over time.

### CROSS-REFERENCE OF RELATED APPLICATION

This application is a Section 371 National Stage Application of International Application No. PCT/GB2022/050261, filed Feb. 1, 2022, and published as WO 2022/167783A1 on Aug. 11, 2022, the content of which is hereby incorporated by reference in its entirety and which claims priority of British Application No. 2101447.7, filed Feb. 3, 2021.

### FIELD

This disclosure relates to a vacuum pressure gauge assembly. This disclosure also relates to a method of indicating a pressure using such a vacuum pressure gauge assembly.

### BACKGROUND

Pressure gauges are commonly used to measure the pressure in industrial systems. The pressure measurement can be used to check that the system has an appropriate pressure for its intended purpose. For example, a vacuum pressure gauge may be used in a vacuum system. If the measurement indicates that the pressure in the system is insufficiently low this can be used to indicate and detect a leak or defect in the system and/or provide feedback to aid control of a vacuum pump evacuating the system.

It is known for vacuum pressure gauges to include a visual status indicator to enable a user to determine whether a system is operating at its intended pressure. In complex systems employing many such gauges, having an integral visual status indicator may enable a user to quickly identify areas of concern.

Some known pressure gauges include a digital interface that displays a pressure readout. Pressure gauges including a digital interface are relatively complex, and may not be economically feasible for large-scale facilities potentially employing hundreds of such gauges. In addition, a user may not be able to easily spot whether one of a large number of gauges is displaying a pressure readout outside of its target range.

It is also known for a pressure gauge to include an LED to provide a visual indication of pressure. In known pressure gauges having an LED indicator, the intensity of the light produced by the LED may reduce to indicate that the pressure is further away from a target setpoint. However, in practice a gauge may appear to be indicating an out-of-range pressure, when in fact the gauge has simply become dirty/dusty, or the LED itself has dimmed/degraded over time.

Accordingly, a need exists to provide a vacuum pressure gauge assembly that improves these aspects of measuring and indicating vacuum pressure.

This description generally exemplifies a pressure sensor for a vacuum pressure gauge assembly as ‘a pressure transducer’, which is generally known to generate a signal (e.g., an electrical signal) as a function of the pressure imposed thereon. As will be appreciated by the skilled person, a broad range of suitable pressure transducers and vacuum pressure gauge assemblies are known, and it is to be understood that any such suitable type or combination of pressure transducer(s) and gauge assembly(ies) may benefit from this disclosure and are accordingly within the scope thereof.

Such types of gauge assemblies may include, for example, Pirani gauge assemblies, thermocouple gauge assemblies, ionization gauge assemblies (e.g. hot-cathode gauge assemblies or cold-cathode gauge assemblies (such as Penning gauge assemblies), magnetron gauge assemblies, inverted magnetron gauge assemblies, wide range gauge assemblies, strain gauge assemblies, etc.

As the working principles of such vacuum pressure gauge assemblies and the pressure transducers (i.e., pressure sensing elements) therein are readily known to the skilled person, they will not be described in further detail here.

The discussion above is merely provided for general background information and is not intended to be used as an aid in determining the scope of the claimed subject matter. The claimed subject matter is not limited to implementations that solve any or all disadvantages noted in the background.

### SUMMARY

From one aspect, the present disclosure provides a vacuum pressure gauge assembly. The assembly comprises a body, a pressure transducer received within the body, a microcontroller received within the body and configured to receive a signal indicative of a pressure from the pressure transducer, and at least one light emitting device in communication with the microcontroller. In general, the body defines an internal chamber for receiving working gas, and the pressure transducer is disposed within the internal chamber and in operable communication with the working gas to generate a signal indicative of the pressure thereof. The microcontroller is configured to process the signal from the pressure transducer to determine the pressure, and to control the at least one light emitting device to display a first light pattern when the pressure is within a first pressure range and a second light pattern different from the first light pattern when the pressure is within a second pressure range different from the first pressure range. At least one of the first light pattern and the second light pattern varies in intensity over time.

In this manner, the vacuum pressure gauge assembly can provide an easily discernible visual indication on the gauge assembly itself to indicate if the vacuum pressure of a system is at appropriate levels or not. This assembly can also do so in a cost-effective manner e.g., compared to providing a digital readout on the gauge assembly.

In one embodiment of the above, the at least one light emitting device comprises at least one light emitting diode (LED).

The light emitting device being an LED makes it cost-effective and easily controllable to produce a multitude of different light patterns that can be accurately controlled.

In a further embodiment of either of the above, the body defines a sidewall that extends between a base and a top along a longitudinal axis, and the top of the body comprises a transparent window for allowing light from the at least one light emitting device to pass through the body, the window having a ring-shape.

The body defining a ring-shaped window (e.g. around the longitudinal axis) allows the light patterns emitted from the device to be seen more easily during use (e.g., from more angles).

In a further embodiment of any of the above, the at least one light emitting device comprises a plurality of light emitting devices that are configured to receive the same signal from the microcontroller such that they are controlled simultaneously.

Using a plurality of light emitting devices controlled simultaneously can provide a more easily seen light pattern during use.

In a further embodiment of any of the above, the vacuum pressure gauge assembly further comprises an interface connector in communication with the microcontroller for receiving power and/or communicating with an external user interface.

The interface connector allows subsequent interrogation and control of the microcontroller to modify the light patterns and pressure ranges they are indicative of, and/or provide a convenient means for connecting a power source to the assembly.

In a further embodiment of any of the above, the vacuum pressure gauge assembly further comprises a user interface device in communication with the microcontroller for allowing a user to enter a configuration mode in which the first pressure range and the second pressure range can be set. The at least one light emitting device is configured to display a colour different from a colour of the first light pattern and a colour of the second light pattern when the pressure gauge assembly is in the configuration mode.

The user interface device provides a convenient ‘on assembly’ means of changing the configuration of the microcontroller e.g. to change the light patterns and pressure ranges they are indicative of. The different colour for the configuration modes means it is made obvious to the user when the configuration mode is active.

From another aspect, the present disclosure also provides a vacuum pressure gauge that includes the assembly of the above aspect or any of its embodiments.

From yet another aspect, the present disclosure provides a method of indicating a pressure using a vacuum pressure gauge assembly. The method comprises the steps of: measuring a pressure using the pressure gauge assembly; determining whether the pressure is within a first pressure range, and, if the pressure is within the first pressure range, operating a light emitting device in the pressure gauge assembly to display a first light pattern; determining whether the pressure is within a second pressure range different from the first pressure range, and, if the pressure is within the second pressure range, operating the light emitting device to display a different, second light pattern. The at least one of the first light pattern and the second light pattern varies in intensity over time.

This method can provide an easily discernible visual indication on a vacuum pressure gauge assembly itself to indicate if the vacuum pressure of a system is at appropriate levels or not. This method can also do so in a cost-effective manner e.g., compared to providing a digital readout on a vacuum pressure gauge assembly.

In one embodiment of the above aspect, the at least one of the first and second light patterns varies between a first intensity value and a second intensity value, and the first intensity value is higher than the second intensity value.

Providing a variation between intensity values may provide light patterns that visually pulse (i.e., ‘blink’ or ‘flash’). Such patterns can be advantageously more visually discernible than other types of light patterns, and so attract attention to a user more effectively.

In a further embodiment of either of the above, the first intensity value is equal to or greater than 50% of the second intensity value.

The intensity value is a percentage of the maximum intensity of light that can be outputted by the light emitting device (e.g., its maximum rated light intensity output).

This differential intensity value is sufficient to provide an easily discernible ‘pulse’ in the light pattern.

In one suitable example, the first intensity value is 100% of maximum intensity and the second intensity value is 50% of maximum intensity. In another suitable example, the first intensity value is 75% of maximum intensity and the second intensity value is 25% of maximum intensity. In yet another suitable example, the first intensity value is 100% and the second intensity value is 25%.

Although the second intensity value may be 0% intensity (i.e., no light) in some examples, in examples where the second intensity value is greater than 0% intensity, it is thought that it can make it easier for a user to determine that the pressure gauge assembly is operating correctly. This is because an assembly where the light emitting device is turned off for a period of time may appear at first glance to not be operational.

In a further embodiment of any of the above, the first light pattern varies between the first and second intensity values at a first frequency and the second light pattern varies between the first and second intensity values at a second frequency, different to the first frequency.

This embodiment provides two light patterns that appear to ‘pulse’ at different frequencies/rates.

In an alternative embodiment to the above, the first light pattern does not vary in intensity over time, and the second light pattern varies in intensity over time.

This embodiment provides a ‘solid light’ for the first light pattern and a ‘pulsing’ pattern for the second light pattern.

In a further embodiment of any of the above, a colour of the first light pattern is different to a colour of the second light pattern.

The colours used can be any suitable colour producible by the at least one light emitting device, such as green, red, blue, purple, orange, yellow, pink, white etc.

These embodiments can provide different light patterns that are clearly visibly distinct from each other. These visual distinctions can be particularly useful where there are a plurality of assemblies used in the same place/plant, as it will be easy to determine and single out which of the plurality of assemblies has detected a fault or sub-optimal pressure, as its pulsing pattern will stick out as different to the light pattern on the others.

In a further embodiment of any of the above, the first pressure range is indicative of a target operational pressure and the second pressure range is indicative of a pressure range outside of the target operational pressure range.

This allows the light patterns to indicate to a user easily and quickly when a particular assembly is detecting a fault or leak in a vacuum system. In a large and complex vacuum system with multiple components, this can help single out which particular component or place in the system the fault or leak can be found.

In a further embodiment of any of the above, the method further comprises determining whether the pressure is within a third pressure range different from the first and second pressure ranges, and, if the pressure is within the third pressure range, operating the light emitting device to display a third light pattern, the third light pattern being different from the first light pattern and the second light pattern.

This third light pattern can be used to provide further information on the pressure range experienced by the assembly. For example, it can allow distinction between a pressure range that is indicative of an acceptable operational pressure range (using the first light pattern), a pressure range that is indicative of a ‘minor’ leak or fault (using the second light pattern) and a pressure range that is indicative of a ‘major’ leak or ‘fatal’ fault (using the third light pattern). Another example includes using the first light pattern to indicate a pressure range being within the ideal operational pressure limit, using the second light pattern to indicate a pressure range that is not ‘ideal’ but still acceptable for operation, and the third light pattern to indicate a pressure range that is not acceptable for operation.

It is to be understood that the method and any of embodiments can utilise the vacuum pressure gauge assembly of the above aspect therein and any of its embodiments.

Although certain advantages have been discussed in relation to certain features above, other advantages of certain features may become apparent to the skilled person following the present disclosure.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF DRAWINGS

One or more non-limiting examples will now be described, by way of example only, and with reference to the accompanying figures in which:

FIG. 1 shows a perspective view of a pressure gauge assembly in accordance with an embodiment of the present disclosure;

FIG. 2 shows a section view of the pressure gauge assembly viewed along line X-X;

FIG. 3 shows a schematic view of the electronic components of the pressure gauge assembly; and

FIG. 4 shows a schematic view of an embodiment of a method of indicating a pressure using the pressure gauge assembly.

### DETAILED DESCRIPTION

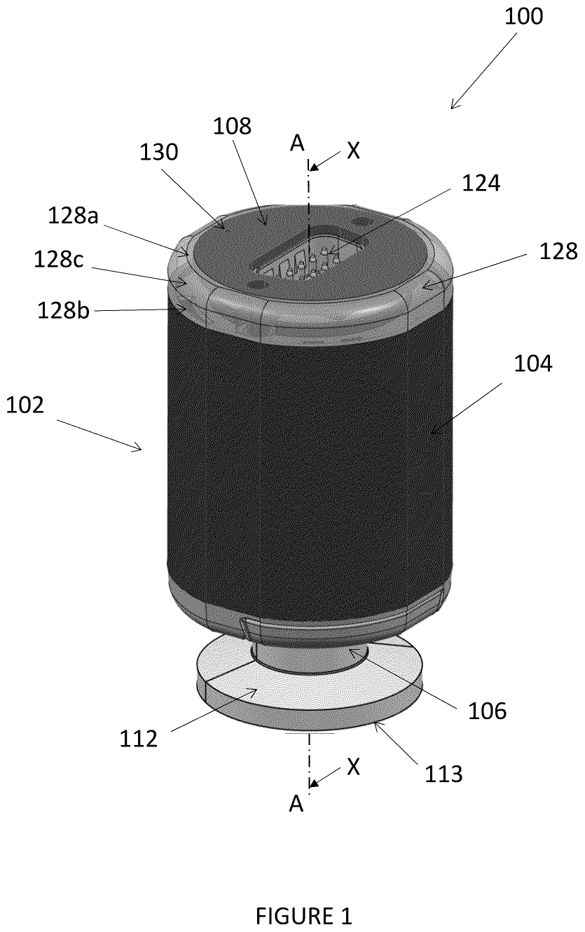

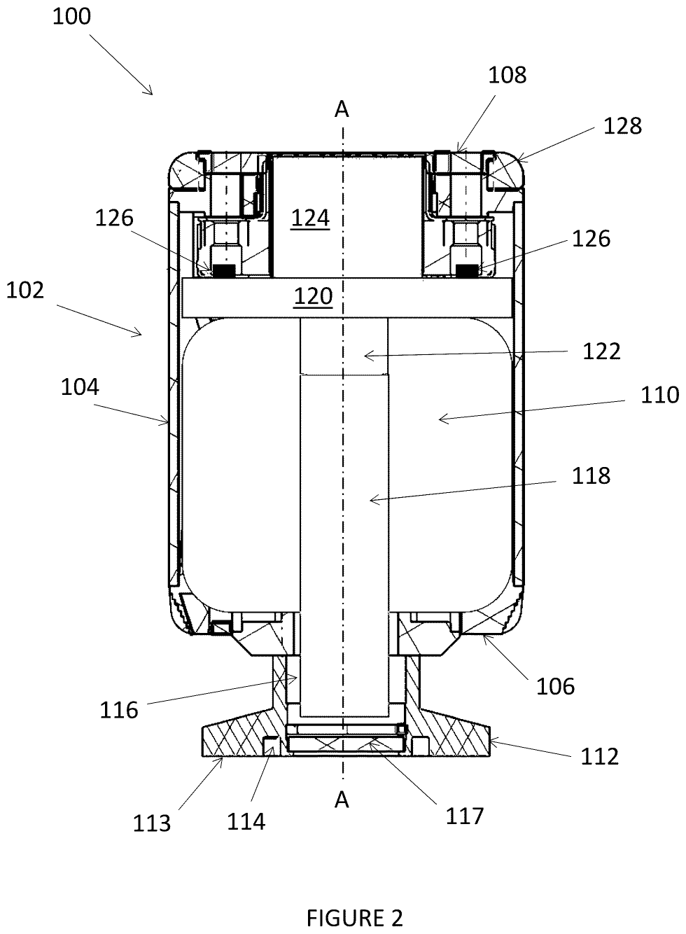

Referring to FIGS. 1 and 2, a pressure gauge assembly 100 is schematically illustrated. In the depicted embodiment, the pressure gauge assembly is a vacuum pressure gauge assembly, which is used for measuring the vacuum pressure of a vacuum system.

The assembly 100 includes a body 102. The body 100 has a sidewall 104 that extends between a base 106 and a top 108 along a longitudinal axis A. In the illustrated embodiment, the body 102 is generally annular and has a circular cross-section along the longitudinal axis A. In other embodiments, the body 102 may have any other suitable cross-section, such as square or rectangular.

The body 102 defines an internal chamber 110 which is configured to receive working or process gas (e.g. from a vacuum system) when the assembly 100 is in use.

By ‘working or process gas’, it is meant the gas (or gases) that the assembly intends to measure the pressure of. The ‘working gas’ is usually the gas (or gases) that are being worked on (e.g. being evacuated by a vacuum system). The pressure of the gas in the chamber 110 can provide an indication of the pressure in the system.

The body 102 could be made of any suitable material, such as a stainless steel or aluminium alloy, or polymeric material (where operating conditions and temperature permit). The body 102 can also be made from any suitable manufacturing method, such as by being moulded/cast, machined from a solid block or 3D printed.

A flange 112 extends from the base 106 of the body 102 along longitudinal axis A. In one example, the flange 112 is of the NW25 specification, although any suitable size and shape of flange may be used within the scope of this disclosure. The flange 112 includes a mating face 113 for interfacing with a system component (not illustrated) from which the pressure is to be measured. The mating face 113 has an annular recess or groove 114 for receiving an O-ring (not illustrated) to provide a seal between the assembly 100 and the component.

The flange 112 defines an inlet passage 116 for the chamber 110. The inlet passage 116 extends axially from the mating face 113, through the flange 112 and into the chamber 110. The inlet passage 116 is in fluid communication with the chamber 110, and permits working gas (e.g. from a vacuum system) to enter and exit the chamber 110 during use.

A filter element 117 is disposed across the inlet passage 116 for filtering the working gas before it enters the chamber 110. The filter element 117 passes radially across the inlet passage 116 relative to the longitudinal axis A. The filter element 117 is used to ensure contaminants do not enter the chamber 110. Such contaminants may damage the assembly 100 (e.g. by corroding or depositing on the pressure transducer 118, body 102, or electrical connections within the chamber 110) and/or may interfere with the pressure measurement process and provide inaccuracies therein. In one example, the filter element 117 is a stainless steel (e.g. 316L) 30-2 mesh, although any other suitable type (e.g. a membrane), material and specification of filter element 117 may be used within the scope of this disclosure.

The inlet passage 116 allows communication of the pressure in a system to a pressure transducer 118 received within the body 102. The pressure transducer 118 is at least partially received and disposed within the chamber 110. A portion of the pressure transducer may also be received within the inlet passage 116. In an exemplary embodiment for use in a vacuum system, the pressure transducer 118 is a filament of a Pirani gauge. In other embodiments, any other suitable pressure transducer (i.e., pressure sensing element) having an appropriate operational range for its intended application may be used.

A microcontroller 120 is received within the body 102. As shown in FIG. 2, the microcontroller 120 is integrated (e.g., surface mounted) to an annular disk of PCB, which is received in the body 104. However, any other suitable method and means for mounting the microcontroller may be used within the scope of this disclosure.

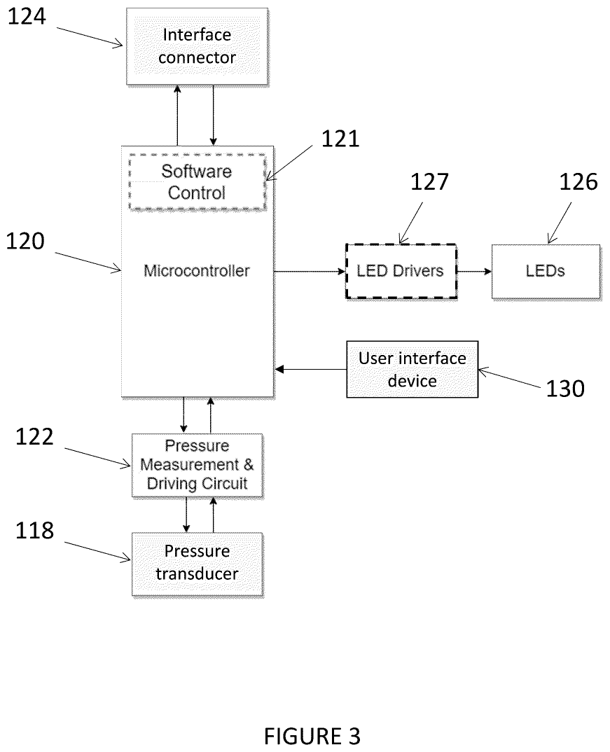

FIG. 3 schematically illustrates the relationship between the microcontroller 120 and the other electrical components of the assembly 100. The microcontroller 120 includes suitable control software 121 stored thereon that controls the behaviour of the assembly 100.

The microcontroller 120 is configured to receive a signal indicative of a pressure from the pressure transducer 118. In the embodiment shown, the microcontroller 120 is connected to the pressure transducer 118 via a pressure measurement and driving circuit 122. The pressure measurement and driving circuit 122 may be any suitable electronic connection for transmitting the signal from the pressure transducer 118 to the microcontroller 120 (e.g., wires, PCB, connector pins etc.).

An interface connector 124 is provided in the top 108 of the body 102. The interface connector 124 is in electrical communication with the microcontroller 120 for receiving power and/or communicating with an external user interface (not shown). In this manner, the interface connector 124 can be connected by a cable to a power source and/or external user interface or device (e.g., a computer) for communicating with the microcontroller 120.

In the depicted embodiment, the interface connector 124 is a D-sub connector. Accordingly, the interface connector 124 can be connected to a power source and/or external user interface using a cable with a complimentary D-sub connector. In other embodiments, any other suitable connector can be used, e.g. such as an RJ45 or USB connector.

Although the interface connector 124 can be used as a connection to a power source, it is to be noted that in other embodiments, alternative power sources and connections thereto can be utilised.

For example, there may be an internal power source, such as a battery, received within the body 102 that is in electrical communication with the microcontroller 120. The battery may be removable and replaceable from the body 102, it may also be a rechargeable battery, such as a Lithium ion battery.

Alternatively, a dedicated power connector may be present on the body 102 (e.g., in addition or alternatively to interface connector 124) that is in electrical communication with the microcontroller 120 for connection to a power source. A mains power source can be used, or the assembly 100 may be connected to take power from the system (e.g., vacuum system or vacuum pump) it is measuring the pressure of.

At least one light emitting device 126 is in electrical communication with the microcontroller 120. In an exemplary embodiment, the at least one light emitting device 126 comprises at least one light emitting diode (LED). The LED(s) is electrically connected to the microcontroller 120 (e.g., via wires/traces on the PCB that supports the microcontroller 120). However, any other suitable type of light emitting device and electrical connection between the device and the microcontroller may be used.

The illustrated embodiment has two light emitting devices 126 that are equally spaced circumferentially around the longitudinal axis A. In other words, they are at 0° and 180° around the circumferential direction of the body 102, respectively. Having such a number and spacing of light emitting devices 126 ensures that a more uniform and visible light signal is emitted from the assembly 100.

In other embodiments, any suitable number of light emitting devices 126 may be used, such as three, four, five or six light emitting devices, and with any suitable spacing or positioning in the body 102 (e.g. linearly spaced or circumferentially spaced, regularly spaced or irregularly spaced).

In an exemplary embodiment, the at least one light emitting device 126 comprises a plurality of light emitting devices 126 that are configured to receive the same signal from the microcontroller 120 such that they are controlled simultaneously. This means the light emitting device 126 will be commanded to emit the same light signal at the same time as each other.

In alternative embodiments, the plurality of light emitting devices 126 may be configured to be individually controlled by the microcontroller 120. For example, two or more light emitting devices 126 may be controlled sequentially to produce the appearance of a ‘moving’ or ‘rotating’ light pattern (e.g., around the circumferential direction of the body 102).

In the illustrated embodiment, the top 108 of the body 102 comprises a transparent window 128 for allowing light from the at least one light emitting device 126 to pass through the body 102. The window 128 has a ring-shape (extending 360° around the longitudinal axis A). The exterior surface of the window 128 comprises a circular portion 128a that extends in a radial plane relative to the longitudinal axis A, a cylindrical portion 128b that extends around the longitudinal axis and a curved portion 128c that connects the circular portion 128a and the cylindrical portion 128b. The circular portion 128a sits flush with the top 108, and the cylindrical portion 128b sits flush with the sidewall 104. The curved portion 128c provides improved diffusion/visibility of light from the window 128 compared with a flat exterior.

In the embodiment shown, the light from the light emitting devices 126 passing through the window 128 provides an illuminated circular ring. In an alternative embodiment, the window 128 may include opaque portions, such that the light from the light emitting device 126 passing through the window 128 provides discrete illuminated portions, such as two, three or four illuminated portions. In other embodiments, the window 128 could be any other suitable shape and/or could be located elsewhere on the body 102, for example at a radially inward position on the top 108 of the body 102, or at an axial location on the sidewall 104 (that is further axially down the body 102 away from the top 108). In an embodiment, the assembly 100 may comprise more than one window 128, such as two, three or four windows.

The window 128 may be formed from any suitable transparent material, such as a polymeric material or glass material. In one exemplary embodiment, the transparent material is a transparent (or clear) acrylic.

As will be appreciated by the skilled person, many different configurations will be available, and will also depend on the particular configuration of light emitting device(s) 126 utilised.

The window 128 can be attached to the body 102 in any suitable manner, for example, using an adhesive or mechanical fitment method (such as an interference fit or a threaded screw fit). The window 128 can be attached either removably or fixedly to the body 102. It will be understood that removable attachment may aid replacement, maintenance and repair of the window 128 and light emitting device(s) 126.

In a further alternative embodiment, the assembly 100 may not comprise a window 128, and the light emitting device 126 may be located in the top 108 or sidewall 104 of the body such that the light emitting device 126 provides illumination directly from the body 102.

A user interface device 130 is provided on the body 102 for allowing a user to enter a configuration mode in which the pressure gauge assembly 100 can be configured. The user interface device 130 is in communication with the microcontroller 120, and when activated acts to place the microcontroller 120 into a configuration mode, where its control functions and settings can be changed.

In the embodiment shown, the user interface device 130 is a button located in the top 108 of the body 102. The button is located in a small pin hole in order to prevent accidental pushing of the button 130.

In alternative embodiments, the user interface device 130 may be any other suitable interface device, such as a switch or touchpad. The user interface device 130 may also be located in any other suitable location on the assembly 100. For example, the user interface device 130 may be located on the sidewall 104.

As mentioned briefly above, the microcontroller 120 is configured to process the signal from the pressure transducer 118 to determine the pressure in the chamber 110, and to control the at least one light emitting device 126 to display a first light pattern when the pressure is within a first pressure range and a different, second light pattern when the pressure is within a second pressure range.

The microcontroller 120 is configured to control the first and second light patterns such that at least one of the first light pattern and the second light pattern varies in intensity over time.

In the depicted example, the microcontroller 120 receives signals from the pressure transducer 118 via the circuit 122. The microcontroller 120 includes an integrated processor and memory that stores instructions thereon to allow it to determine the pressure that the signal is indicative of, and determine whether that pressure is within one of any suitable number of pressure ranges. The microcontroller 120 will then control the light emitting device(s) 126 to display a corresponding light pattern according to the pressure range determined. The instructions (and thus pressure ranges and light patterns) can be updated/changed using the software control 121. For example, by connecting an external user interface to the microcontroller 120 using connector 124 (as discussed above), or activating interface device 130, to access and utilise the software control 121.

In further examples, the microcontroller 120 could be configured to determine whether the pressure is within one of three, four, or more different pressure ranges.

Accordingly, it should be understood that features discussed herein in relation to the first and/or second light pattern are also applicable to any other additional light pattern corresponding to other pressure ranges.

In accordance with this disclosure, there are various ways in which the corresponding light patterns can be made ‘different’ (i.e., visually distinguishable) from each other, as will be discussed in more detail below.

The variation in intensity may be seen as a discernible ‘pulse’, ‘blinking’ or ‘flashing’ of light. For example, a light pattern that varies between a first intensity value and a second intensity value, where the first intensity value is higher (i.e., provides a ‘brighter’ light) than the second intensity value, is considered to be ‘pulsing’, ‘blinking’ or ‘flashing’. The first intensity value is visually distinguishable from the second intensity value.

The first and second intensity values can be defined as a percentage of the maximum intensity that the light emitting device(s) 126 is capable of outputting.

In some embodiments, the first intensity value is the maximum intensity of light that the light emitting device 126 is capable of outputting, referred to herein as maximum intensity or 100% intensity. In other embodiments, the first intensity value may be less than the maximum intensity that the light emitting device 126 is capable of outputting, for example, 95%, 90%, 85%, 80%, 75% or 70% of the maximum intensity.

In some embodiments, the second intensity value has 0% intensity, in other words, no light is provided (i.e., the light emitting device 126 is ‘off’). In other embodiments, the second intensity value has a lower intensity than the first intensity value but is greater than 0% intensity, for example 20%, 25% or 30%, 40% or 50% of the maximum intensity.

Having the second intensity value greater than 0% intensity may advantageously make it easier for a user to determine that the pressure gauge assembly 100 is operating correctly, as an assembly 100 where the light emitting device is turned off for a period of time may appear at first glance to not be operational.

In an exemplary embodiment, the first intensity value is 100% of maximum intensity and the second intensity value is 50% of maximum intensity. In another exemplary embodiment, the first intensity value is 75% of maximum intensity and the second intensity value is 25% of maximum intensity. In yet another embodiment, the first intensity value is 100% and the second intensity value is 25%.

In practice, suitable intensity values will be determined based on the capabilities of the light emitting devices 126 used in the device and the intended application (e.g., how dark or bright the ambient conditions around the assembly 100 are).

The period of time at which the light emitting device 126 is held at the first intensity value and the second intensity value may also be varied.

In an exemplary embodiment, the light pattern is defined by a frequency, (or pulse/blink rate), at which the intensity value switches between the first and second intensity value. In embodiments, the first and second light patterns may have different frequencies to each other, in order to provide a visual distinction between the two (e.g., so the first light pattern pulses at a slower frequency than the second light pattern or vice versa).

Within each cycle of switching between the first and second intensity value, the first intensity value may be held for a first percentage of the cycle, and the second intensity value may be held for a second percentage of the cycle. The first percentage and the second percentage may be equal (i.e. both 50%). Alternatively, the first percentage may be greater than the second percentage, or the second percentage may be greater than the first percentage. For example, the first percentage may be 75% and the second percentage may be 25%. This can be used to further vary the visual appearance of the pulsation between the first and second intensity values for each light pattern.

In an alternative embodiment, the light pattern may not vary at a regular frequency, but instead vary in a non-regular manner. For example, the pulses between the first and second intensity values may occur at non-regular time intervals, or at variable frequencies. In further alternative embodiments, the light pattern may also vary between various different intensity values, not just a fixed first and second intensity value. These features may allow a more unique or noticeable light pattern to be produced.

As will be appreciated by the skilled person, the intensity value and variation therein over time for the light pattern can be controlled by the microcontroller 120, for example, by controlling the amount of voltage delivered to the light emitting device(s) 126 for a given time period of time.

In one exemplary embodiment, one of the first light pattern or the second light pattern is a ‘solid light’ that does not vary in intensity over time (whilst the other light pattern does). In such an embodiment, the pressure gauge assembly 100 is configured such that the solid light pattern is indicative of a pressure range representative of a desired operational range. Such a solid light pattern may be more noticeably recognisable as a default operational state, and make it easier to see any deviation from this default operational state.

In another exemplary embodiment, the light emitting device 126 is capable of emitting two or more different colours of light. In such an embodiment, the microcontroller 120 controls the light emitting devices 126 to emit a different colour during the first light pattern than during the second light pattern. In another embodiment, the microcontroller 120 controls the light emitting devices 126 to emit a different colour during the first intensity value of a light pattern than during the second intensity value of the light pattern. It will be appreciated that such embodiments may increase the distinguishability between different light patterns, and may be advantageous in embodiments utilising a large number of different light patterns. The different colour can be any suitable colour that can be emitted from the light emitting device(s), e.g., green, blue, red, yellow, purple, orange etc.

It will thus be appreciated that it is necessary for the first light pattern to be visually distinguishable from the second light pattern, and as discussed above, this may be achieved in a number of ways. For example, ‘pulsing’ the first light pattern in a different pattern or at a different frequency to the second light pattern, and/or providing variations in intensity and colours between the first and second light patterns.

In some embodiments, it may be advantageous for the microcontroller 120 to control the light emitting device 126 to emit the same colour during the first and second light patterns. Such embodiments may assist in communicating to a user that the pressure gauge assembly 100 is in an operational mode. For example, the colour green is typically associated with an ‘on’ and operational mode in industrial applications, and a user may understand from the use of the colour green for both the first and second light patterns that the pressure gauge assembly 100 is ‘on’ and operating correctly.

The colour of the light displayed by the light emitting device may also be used to communicate to a user that the pressure gauge assembly 100 is not in an operational mode.

For example, in the configuration mode, the first pressure range and the second pressure range can be set. In an exemplary embodiment, the at least one light emitting device 126 is configured to display a colour different from a colour of the first light pattern or a colour of the second light pattern when the pressure gauge assembly 100 is placed into configuration mode by activating interface device 130.

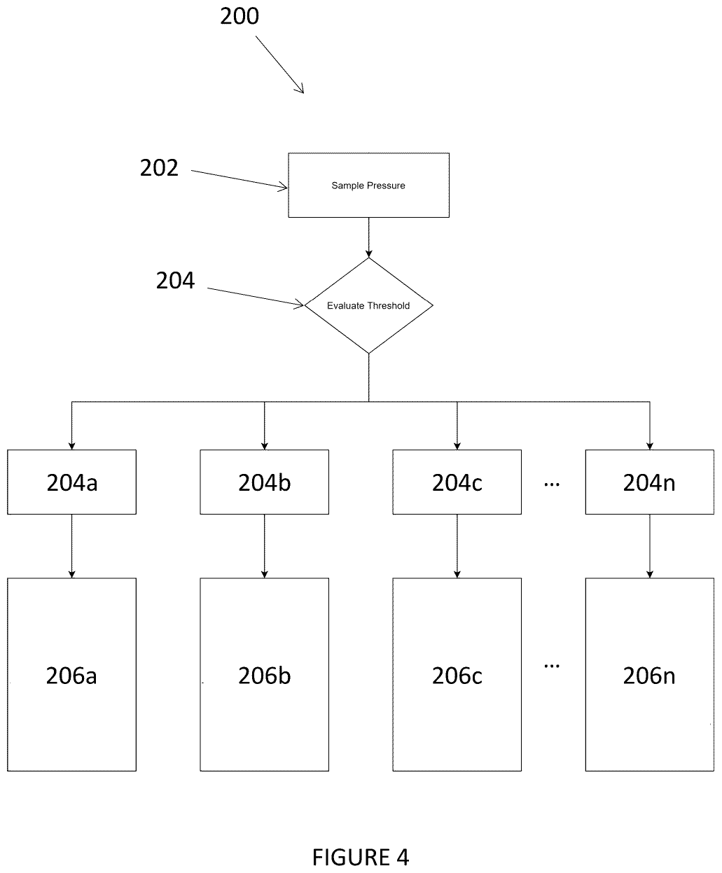

FIG. 4 schematically illustrates a method 200 of indicating a pressure using the pressure gauge assembly 100. Step 202 comprises measuring a pressure (P) using the pressure gauge assembly 100. Step 204 comprises evaluating the pressure, for example by using the microcontroller 120 to process a signal output from the pressure transducer 118 to determine the pressure indicative thereof.

Step 204a comprises determining whether the pressure falls within a first pressure range. If the pressure is within the first pressure range, the light emitting device(s) 126 in the pressure gauge assembly 100 is operated to display the first light pattern (step 206a).

Step 204b comprises determining whether the pressure falls within a second pressure range. If the pressure is within the second pressure range, the light emitting device 126 is operated to display the second light pattern (step 206b).

In an embodiment, the method 200 further comprises determining whether the pressure is within a third pressure range (step 204c). If the pressure is within the third pressure range, the light emitting device 126 is operated to display a third light pattern (step 206c). The third light pattern is to be different (i.e., visually distinct) from the first light pattern and the second light pattern. Similar steps 204n, 206n may be repeated for any suitable number of pressure ranges and corresponding light patterns.

The above steps of determining whether the pressure is within a given range and operating the light emitting device 126 are carried out by the microcontroller 120. The microcontroller 120 may repeat these steps at any suitable frequency to ensure the correct pressure range condition and light pattern is indicated accordingly to the operational state of the vacuum system. For example, the indicated pressure range may be checked by the microcontroller 120 (and light pattern maintained or changed accordingly) multiple times a second, once every second, or once every 5 seconds.

As will be appreciated, less sensitive systems may need less frequent updates. Also, it may be beneficial to check the pressure ranges less frequently in certain less sensitive applications, to avoid minor and short term pressure fluctuations outside of the ideal operational range providing unnecessary alarm.

An example method for measuring and indicating vacuum pressure using the gauge assembly 100 is discussed below.

The different pressure ranges required for indication in the system are defined by a number of set points (P₁, P₂ . . . Pₙ) representing the respective boundaries of each pressure range.

A first set point (P₁) and a second set point (P₂) are selected, and pressure ranges are defined as follows:
First pressure range: P≤P₁
Second pressure range: P₁<P≤P₂
Third pressure range P>P₂

The first set point (P₁) represents the maximum operational pressure, below which it is considered that a suitable vacuum has been achieved. Accordingly, the first pressure range is indicative of a target operational pressure. In an example, P₁=0.001 mbar (0.1 Pa).

The second set point (P₂) represents a threshold pressure above which the pressure system may be considered to be not functioning properly or indicative of a minor system leak. In an example, P₂=1 mbar (100 Pa) (e.g., ‘rough’ vacuum boundary).

Accordingly, the second pressure range is indicative of a pressure range outside of the target operational pressure range. The second pressure range may, however, still be within safe or practical limits for continued operation. In contrast, above the third range may indicate a range of pressures above the second range that provides an indication of a fatal/dangerous pressure range, or complete equipment/vacuum failure.

As will be appreciated, these pressure ranges and indications provided thereby can be readily adjusted as necessary for particular applications.

In an exemplary embodiment, the light patterns are defined by the following parameters:
intensity variation frequency (F)
proportion of time at first intensity value (T₁)
first intensity value (I₁)
colour at first intensity value (C₁)
proportion of time at second intensity value (T₂)
intensity at second intensity value (I₂)
colour at second intensity value (C₂)

In an embodiment, the first light pattern corresponding to the first pressure range is defined by:
F=0 Hz
T₁=100%
I₁=100% of maximum intensity
C₁=Green
T₂=0%
I₂=0% of maximum intensity
C₂=off (no colour)

In other words, the first light pattern in a solid light that does not vary with intensity over time.

The second light pattern corresponding to the second pressure range is defined by:
F=1 Hz
T₁=75%
I₁=100% of maximum intensity
C₁=Yellow
T₂=25%
I₂=25% of maximum intensity
C₂=Blue

In other words, the second light pattern varies between a ‘brighter’ yellow light and ‘dimmer’ blue light once per second, with the yellow light being on for three quarters of a second and the blue light being on for a quarter of a second.

The third light pattern corresponding to the third pressure range is defined by:
F=1 Hz
T₁=50%
I₁=100% of maximum intensity
C₁=Green
T₂=50%
I₂=50% of maximum intensity
C₂=Green

In other words, the third light pattern oscillates between a brighter green light and dimmer green light once per second, spending an equal period of time (half a second) at each intensity level.

As will be appreciated, a user of the pressure gauge assembly 100 utilising the light patterns described above would be able to readily distinguish between the three different light patterns, and determine which of the three pressure ranges the pressure being measured fell within.

In a scenario utilising multiple such pressure gauge assemblies 100 in different areas of a system (for example a large-scale industrial facility), the user could readily identify areas of the system not within target operational pressure ranges by looking for the pressure gauge assemblies 100 displaying a light pattern that varies in intensity over time.

The examples discussed above should not be considered limiting, and simply serve to demonstrate some of the potential variations between different light patterns that could be made within the scope of this disclosure. It will be appreciated that light patterns comprising many other combinations of frequency, timing, intensity and colour are contemplated within the scope of this disclosure.

For example, in an embodiment where the different light patterns all utilise the same colour, a light pattern corresponding to a pressure range further from the target operational pressure range having a higher pulse frequency than a light pattern corresponding to a pressure range closer to the target operational pressure range.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum pressure gauge assembly comprising:
a body;
a pressure transducer received within the body;
a microcontroller received within the body and configured to receive a signal indicative of a pressure from the pressure transducer; and
at least one light emitting device in communication with the microcontroller;
wherein the microcontroller is configured to process the signal from the pressure transducer to determine the pressure, and to control the at least one light emitting device to display a first light pattern when the pressure is within a first pressure range and a second light pattern different from the first light pattern when the pressure is within a second pressure range different from the first pressure range, and wherein at least one of the first light pattern and the second light pattern varies in intensity over time.

2. The vacuum pressure gauge assembly of claim 1, wherein the at least one light emitting device comprises at least one light emitting diode (LED).

3. The vacuum pressure gauge assembly of claim 1, wherein the body defines a sidewall that extends between a base and a top along a longitudinal axis, and the top of the body comprises a transparent window for allowing light from the at least one light emitting device to pass through the body, the window having a ring-shape.

4. The vacuum pressure gauge assembly of claim 1, wherein the at least one light emitting device comprises a plurality of light emitting devices that are configured to receive the same signal from the microcontroller such that they are controlled simultaneously.

5. The vacuum pressure gauge assembly of claim 1, further comprising an interface connector in communication with the microcontroller for receiving power and/or communicating with an external user interface.

6. The vacuum pressure gauge assembly of claim 1, further comprising a user interface device in communication with the microcontroller for allowing a user to enter a configuration mode in which the first pressure range and the second pressure range can be set, wherein the at least one light emitting device is configured to display a color different from a color of the first light pattern and a color of the second light pattern when the pressure gauge assembly is in the configuration mode.

7. A method of indicating a pressure using a vacuum pressure gauge assembly, comprising:
measuring a pressure using the pressure gauge assembly;
determining whether the pressure is within a first pressure range, and, if the pressure is within the first pressure range, operating a light emitting device in the pressure gauge assembly to display a first light pattern;
determining whether the pressure is within a second pressure range different from the first pressure range, and, if the pressure is within the second pressure range, operating the light emitting device to display a different, second light pattern;
wherein at least one of the first light pattern and the second light pattern varies in intensity over time.

8. The method of claim 7, wherein the at least one of the first and second light patterns varies between a first intensity value and a second intensity value, and the first intensity value is higher than the second intensity value.

9. The method of claim 8, wherein the first intensity value is equal to or greater than 50% of the second intensity value.

10. The method of claim 8, wherein the first light pattern varies between the first and second intensity values at a first frequency and the second light pattern varies between the first and second intensity values at a second frequency, different to the first frequency.

11. The method of claim 7, wherein the first light pattern does not vary in intensity over time, and the second light pattern varies in intensity over time.

12. The method of claim 7, wherein a color of the first light pattern is different to a colour of the second light pattern.

13. The method of claim 7, wherein the first pressure range is indicative of a target operational pressure and the second pressure range is indicative of a pressure range outside of the target operational pressure range.

14. The method of claim 7, further comprising determining whether the pressure is within a third pressure range different to the first and second pressure ranges, and, if the pressure is within the third pressure range, operating the light emitting device to display a third light pattern, the third light pattern being different from the first light pattern and the second light pattern.

15. (canceled)
